(19) United States
(12) Patent Application Publication
(10) Pub. No.: US 2008/0117714 A1
(43) Pub. Date: May 22, 2008

(54) Pitcher Arrangement for a Blending Device

(75) Inventors: Henrik Pavlovic, Slowenien (SI); Aleksander Sedovsek, Mozirje (SI); Uros Semeja, Smartno ob Paki (SI); Igor Zibret, Smartno ob Paki (SI)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 10/541,141

(22) PCT Filed: Dec. 18, 2003
(86) PCT No.: PCT/EP03/14470

§ 371 Date: Aug. 16, 2007

(30) Foreign Application Priority Data
Dec. 30, 2002 (DE) 102 61 367.2

(51) Int. Cl. A47J 43/07

(52) U.S. Cl. 366/242

(57) ABSTRACT

A pitcher arrangement for a blending device (10), comprising a pitcher (22) and a pitcher support (28) which is mounted on the pitcher (22) via a connecting mechanism, preferably a threaded connection. A locking mechanism, by means of which the connecting mechanism can be locked in the assembled position thereof, is provided between the pitcher (22) and the pitcher support (28) when the pitcher (22) is in the assembled position.

The invention relates to a pitcher arrangement for a blending device according to the introductory part of patent claim 1.

Blending devices for the household are known. These so-called blenders or mixers comprise a motor housing with an electric drive motor and a pitcher which can be placed on an upper side of the housing and in the lower region of which a tool shaft can rotate about a vertical axis. The downwardly open pitcher can be taken off the housing, together with a base region, in order to be able to empty the previously comminuted and/or finely intermixed content into a vessel. The base region is typically formed as a so-called pitcher support which seals off the pitcher, which is connected therewith, outwardly and relative to the motor and which at the same time forms a mount for the tool shaft separable from a driven shaft of the drive motor. The tool shaft can be centred by means of a bearing plate fixable in the bowl carrier and having a slide bearing. Such a blending device according to category is evident from, for example, DE-GM 75 07 736.

The known blending devices mostly have, at the annular lower collar of the pitcher, an external thread which co-operates with a corresponding internal thread of the pitcher support. Since on screwing-in of the pitcher an inserted sealing ring usually has to be compressed, the fully locked position is not precisely defined, but depends in the first instance on a torque applied by the user. Under unfavourable conditions, particularly in the case of vibrations arising during operation, this can lead to loosening of the pitcher and in a given case to leakages and escape of liquid.

The present invention has the object of making available a reliable and tight connection between a pitcher and a blending device.

This object is fulfilled, in the case of a pitcher arrangement for a blending device with the features stated in the introductory part of patent claim 1, in that when the pitcher is mounted a detent device, by which the connecting device can be detented in its mounted position, is provided between the pitcher and the pitcher support. The pitcher able to be inserted or screwed into the pitcher support thus has a defined end position which is defined by corresponding abutment or detent devices. These are respectively arranged in the pitcher support and at the pitcher foot and ensure that the pitcher on insertion into the pitcher support always rotates against a defined abutment and can be detented there. This defined end position is no longer dependent on a feeling of a respective user. It also does not change with increasing aging of a seal, which in a given case is subject to plastic deformation.

The detent devices are preferably formed by means of at least one pair of mutually matching detent means, particularly by a projection and a cut-out, which in the mounted end position of the connecting device can be brought into mutual engagement. In particular, the projection can be arranged at the pitcher and the cut-out at the pitcher support, or conversely. The projection respectively engaging in the cut-out represents a simple and reliable detent means which largely excludes faulty operation.

Preferably, two pairs of detent means are arranged to lie diametrically opposite. The possible configurations of the detent devices ensure the desired defined end position of the pitcher, so that this can be inserted neither too firmly nor too loosely into the pitcher support. A screwing-in which is too loose could lead to loosening of the pitcher in the case of vibrations occurring during operation and thus to leakage. A twisting-on which is too firm could be accompanied by crushing of a seal. The seal can thereby be damaged, so that leakage can similarly occur. Moreover, a pitcher which is screwed on too firmly can in certain circumstances no longer be released by hand in the case of temperature differences arising between the threaded parts. The presence in each instance of at least two projections or cut-outs ensures a uniform distribution of force and centring of the pitcher in the bowl carrier.

The connecting device is preferably constructed as a threaded connection or a bayonet connection. The detent device can thus be brought into engagement in the mounted end position of the connecting device. A further connecting device, preferably a bayonet device, for mounting the pitcher support on the blending device can be provided at the pitcher support. Through provision of the detent devices the connecting device between the pitcher and pitcher support can preferably be released more easily than the further connecting device between the pitcher support and the blending device.

In addition, a bearing plate, through which a tool shaft is mounted, can be arranged between the pitcher and the pitcher support. The bearing plate can be fixed and centred between pitcher and pitcher support, so that the tool shaft has a defined axis of rotation and height position.

Further aspects and advantageous developments of the invention are evident from the dependent claims as well as from the following description of figures.

The invention is explained in more detail in the following on the basis of an example of embodiment with reference to the accompanying drawings, in which:

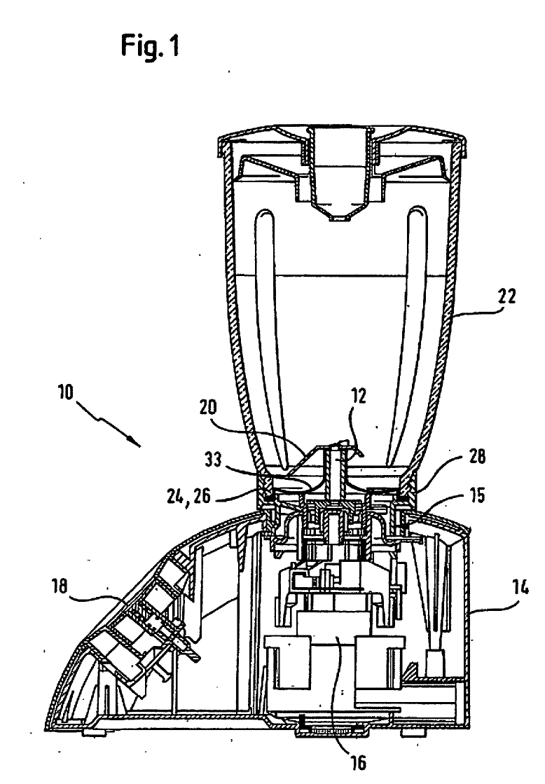

FIG. 1 shows a schematic sectional illustration of a blending device according to the invention and

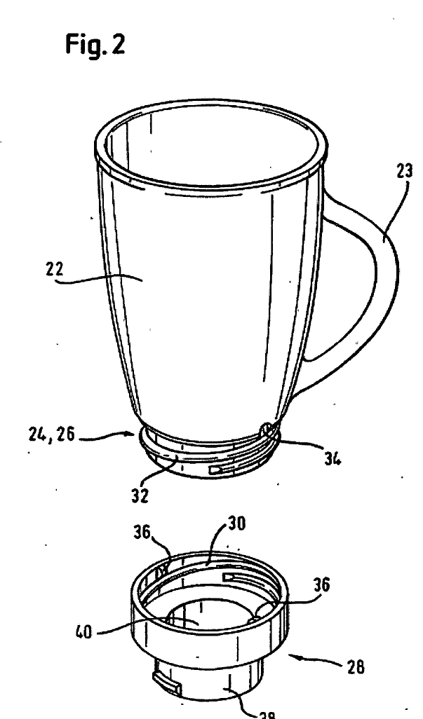

FIG. 2 shows an exploded illustration of a removed pitcher of the blending device corresponding with FIG. 1.

FIG. 1 shows a blending device 10 according to the invention in a schematic sectional illustration. The blending device 10 has a rotating tool shaft 12 and comprises a housing 14 with a drive device, preferably an electric drive motor 16, arranged therein as well as an actuating device 18 for actuating the blending device 10. The tool shaft 12 with knives 20 arranged thereat has a vertical axis of rotation and projects into a pitcher 22 which is placed in a receptacle 15 on an upper side of the housing 14 and can be removed therefrom in the case of need. The pitcher 22 can have, in a given case, a lateral handle 23 (cf. FIG. 2).

The pitcher 22 has an open underside 24 with an annular pitcher foot 26, which has a cylindrical outer circumferential surface with an external thread 32 disposed thereon or a bayonet coupling or the like. This corresponds with a corresponding internal thread 30 or a counter-coupling of a bayonet lock of a pitcher support 28. The pitcher support 28 can be removed, together with the pitcher 22, from the housing 14 and in this case seals the open underside 24 of the pitcher 22. When the pitcher 22 is firmly connected with the pitcher support 28 the tool shaft 12 also remains connected with the pitcher 22 when this is removed, since the tool shaft 12 is mounted in a bearing plate 33 fixed between pitcher 22 and pitcher support 28.

FIG. 2 shows clearly the pitcher 22 which is removed from the pitcher support 28 and which tapers in downward direction and carries the external thread 32 at the pitcher foot 26. The underside 24 of the pitcher 22 is open so that when the pitcher 22 is in place the tool shaft (FIG. 1) projecting out of an opening 40 of the pitcher support 28 is arranged within a lower section of the pitcher 22.

The pitcher 28 has an internal thread 30 complementary to the external thread 32, so that the pitcher foot 26 can be screwed together with the pitcher support 28. A sealing ring (not illustrated), which ensures reliable sealing of the pitcher 22 during operation, is preferably provided at the base of the internal thread 30. Alternatively thereto there can also be provided a bayonet closure which similarly makes possible a sealed connection. An insert 38 provided below the threaded region of the pitcher support 28 serves for insertion into the receptacle 15 of the housing 14.

Two projections 36 arranged opposite one another are recognisable at an upper edge within the internal thread 30 of the pitcher support 28 and project out of the internal thread 30, the projections being part of a detent device for definition of an end position of the screwed-in pitcher 22. The pitcher 22 has, at an upper edge of its external thread 32 at the pitcher foot 26, cut-outs 34 which are complementary thereto and which co-operate with the projections 36 as soon as the pitcher 22 is fully screwed in. In that case the projections 36 engage in the cut-outs 24 and prevent further rotation of the pitcher 22 beyond the end position.

Instead of the illustrated respective two projections 36 and cut-outs 34 there can also be provided in each instance only one cut-out and one projection. Similarly, however, also three or more pairs of co-operating projections and cut-outs can be provided. These can be respectively arranged at the upper or lower edges of the external or internal thread so that detenting takes place not during screwing-in, but only directly on reaching the end position. Instead of the illustrated arrangement with the projections 36 provided at the internal thread 30 also the cut-outs 34 can be provided there. In this connection, the projections 36 are provided at the external thread 32 of the housing foot.

Preferably the force to be applied for releasing the detent connection between pitcher 22 and pitcher support 28 is less than that for releasing the insert 38 from the receptacle 15 of the housing 14, so that basically only this connection is separated.

A coupling between driven shaft of the drive motor 16 and tool shaft 12 can avoid the tool shaft 12, lying open in the pitcher support 28, still being coupled with the drive motor 16, which can lead to injuries if this is still not switched off or is erroneously switched on.

1-7. (canceled)

8. A pitcher arrangement for a blending device, comprising a pitcher and a pitcher support being mountable on the pitcher by way of a connecting device, and when the pitcher is mounted a detent device, by which the connecting device can be detented in its mounted position, is provided between the pitcher and the pitcher support, wherein the detent device has at least one pair of complementary detent means, which can be brought into mutual engagement in the mounted end position of the connecting device in such a manner that further rotation of the pitcher beyond the end position is prevented.

9. The pitcher arrangement according to claim 8, wherein the connecting device includes a threaded connection.

10. The pitcher arrangement according to claim 8, wherein the detent means includes a projection and a cut-out.

11. The pitcher arrangement according to claim 10, wherein the projection is arranged at the pitcher and the cut-out is arranged at the pitcher support.

12. The pitcher arrangement according to claim 10, wherein the projection is provided at the pitcher support and the cut-out is provided at the pitcher.

13. The pitcher arrangement according to claim 10, wherein the connecting device includes a threaded connection having an internal thread and an external thread, the projection and the cut-out being respectively arranged at one of upper and lower edges of one of the external thread and the internal thread so that detenting takes place not during the screwing-in, but only directly on reaching the end position.

14. The pitcher arrangement according to claim 8, wherein two pairs of detent means are disposed diametrically opposite one another.

15. The pitcher arrangement according to claim 8, wherein the pitcher support has a further connecting device for mounting the pitcher support on the blending device and that through the provision of the detent device the connecting device between pitcher and pitcher support can be more easily detached than the further connecting device between the pitcher support and the blending device.

16. The pitcher arrangement according to claim 15, wherein the further connection device includes a bayonet connection.

17. A pitcher arrangement for a blending device, comprising:
a pitcher having an open underside;
a pitcher support mountable on the pitcher to close the open underside;
a connecting means for connecting the pitcher support to the pitcher in a mounted end position; and
at least one pair of complementary detent means on at least one of the pitcher and the pitcher support, the detent means being in mutual engagement with one another in the mounted end position and resisting further rotation of the pitcher with respect to the pitcher support beyond the mounted end position.

18. The pitcher arrangement according to claim 17, wherein the complimentary detent means includes a mating projection and cut-out with the projection disposed on the pitcher and the cut-out disposed on the pitcher support.

19. The pitcher arrangement according to claim 17, wherein the complimentary detent means includes a mating projection and cut-out with the projection disposed on the pitcher support and the cut-out disposed on the pitcher.

20. The pitcher arrangement according to claim 17, wherein the connection means comprises a threaded connection including an external thread on the pitcher and an internal thread on the pitcher support.

21. The pitcher arrangement according to claim 20, wherein the complimentary detent means includes a mating projection and cut-out with the projection disposed on the pitcher support and the cut-out disposed on the pitcher and being engagable with one another, the projection and the cut-out being arranged at a corresponding edge including at least one of an upper edge and a lower edge of the external and internal threads, wherein engagement of the projection and cut-out is avoided while the pitcher support is being threaded onto the pitcher and permitted after the pitcher support reaches the mounting end position on the pitcher.

22. The pitcher arrangement according to claim 17, further comprising two pairs of detent means disposed diametrically opposite one another.

23. The pitcher arrangement according to claim 17, wherein the pitcher support includes a bayonet connection releaseably connecting the pitcher support to the blending device, the detent means between the pitcher and the pitcher support being more easily detached than the bayonet connection the pitcher support and the blending device.

24. A pitcher assembly for a blending device, comprising:
a pitcher including an annular pitcher foot disposed near a bottom portion of the pitcher and forming an open underside for receiving a rotating tool shaft, the pitcher foot having an external thread and forming a recessed cut-out near the external thread; and
a pitcher support removably engaging the pitcher foot and sealing the open underside, the pitcher support having an internal thread threadingly engaging the external thread of the pitcher foot and a projection extending radially inwardly from the pitcher support near the internal thread and engaging the cut-out when the pitcher support is threaded onto the pitcher foot, the projection and the cut-out resisting rotational movement of the pitcher in relation to the pitcher support when the projection and cut-out engage one another.

25. The pitcher assembly according to claim 24, wherein the pitcher foot includes a plurality of recessed cut-outs and the pitcher support includes a plurality of projections extending radially inwardly, each projection engaging a corresponding cut-out when the pitcher support is threaded onto the pitcher foot to resist rotational movement of the pitcher in relation to the pitcher support.
